(19) United States
(12) Patent Application Publication
(10) Pub. No.: US 2007/0183068 A1
(43) Pub. Date: Aug. 9, 2007

(54) Power adjust rear view mirror

(76) Inventor: Paul J. Kozlowski, Sterling Heights, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/346,839

(22) Filed: Feb. 3, 2006

(51) Int. Cl. G02B 7/182

(52) U.S. Cl. 359/877; 359/872

(57) ABSTRACT

A power-adjust rear view mirror system. The power-adjust rear view mirror system includes a power-adjust mechanism structure coupled to a mirror structure both of which are located within a vehicular passenger compartment. One or more control pads include operating devices that, when actuated, cause the power-adjust mechanism structure to manipulate the vertical pitch and horizontal pitch position of the mirror structure.

### BACKGROUND

Rear-view mirrors are located within the interior of the vehicle passenger compartment and provide a vehicle operator with a rearward view of the surrounding environment. It is known that the vertical pitch and/or horizontal pitch of rear-view mirrors may be manually adjusted by hand to provide a vehicle operator with an unobstructed, optimizes rear view of the surrounding environment of the vehicle to his/her liking.

A support structure is commonly used for retaining the position of the rear-view mirror. However, the support structure may change over time, thereby failing to retain the desired vertical and/or horizontal pitch positioning of the rear-view mirror. Further, if operation of the vehicle is shared amongst two or more vehicle operators, the vehicle operators are inconvenienced by having to manually manipulate the vertical and/or horizontal pitch of the rear-view mirror to accommodate each driver's preference.

An embodiment of the present disclosure eliminates the need to manually adjust the vertical and/or horizontal pitch of the rear-view mirror. Another embodiment of the present disclosure provides a memory that stores a plurality of rear-view mirror vertical and/or horizontal pitch settings for automatically accommodating the preferences of multiple vehicle operators.

### BRIEF DESCRIPTION OF THE DRAWINGS

The disclosure will now be described, by way of example, with reference to the accompanying drawings, in which:

FIG. 1 is a schematic view of an embodiment of the rear-view mirror system of the present invention;

FIG. 2 is an environmental view of a passenger compartment illustrating possible locations of one or more control pads.

FIG. 3 is a top/left isometric view of a rear-view mirror structure, power-adjust mechanism structure, and support structure according to the system of FIG. 1, and;

FIG. 4 is a, partial cross-sectional view of the left side of the power-adjust mechanism structure and support structure according to FIGS. 1 and 3.

FIG. 5 is a schematic drawing of several components that could be contained in an embodiment of the vertical and horizontal pitch mechanism.

### DETAILED DESCRIPTION

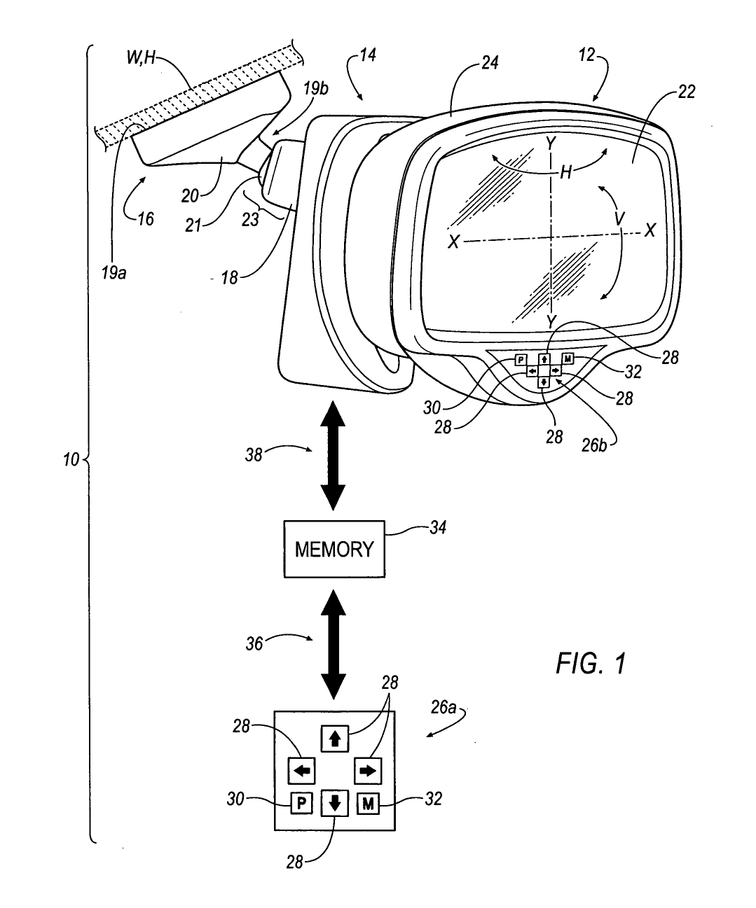

Referring to FIG. 1, a power-adjust rear-view mirror system is shown generally at 10 according to an embodiment. The illustrated power-adjust rear-view mirror system 10 is shown comprising a mirror structure 12, a power-adjust mechanism structure 14, a support structure 16, one or more control pads 26a, 26b, and a memory 34. The support structure 16 may include an attachment feature (e.g. a rod) 18 and a base 20. According to the illustrated embodiment, a first end 19a, of the base 20 may be affixed to an inboard surface of a front windshield, W, or headliner, H, and a second end 19b of the base 20 includes an engagement surface 21 (such as a spherical shaped surface) for attachment to a mating surface (such as a socket) of rod 18. The mirror structure 12 may include a mirror 22 and a frame 24. Engagement surface 21 of base 20 and mating surface of rod 18 form joint 23.

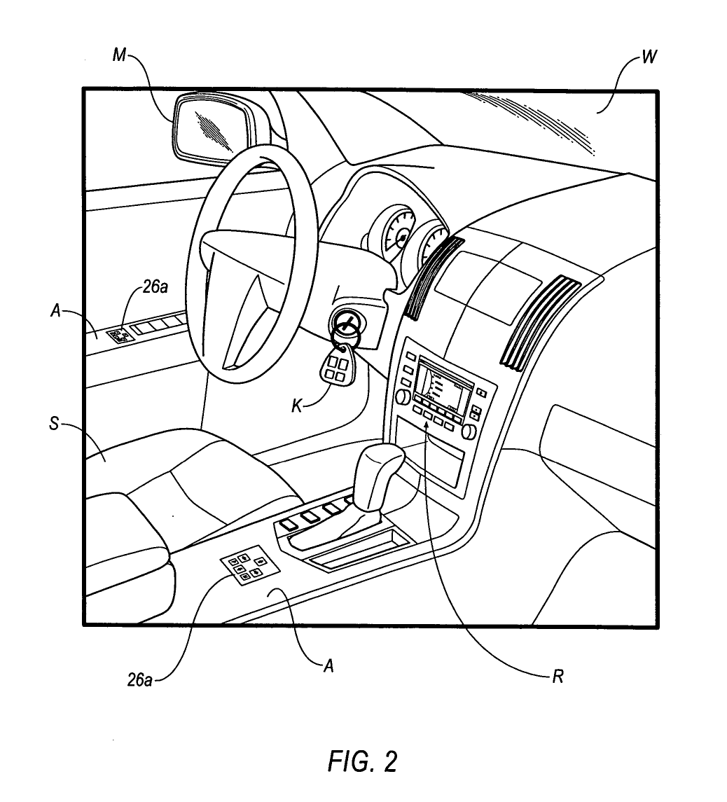

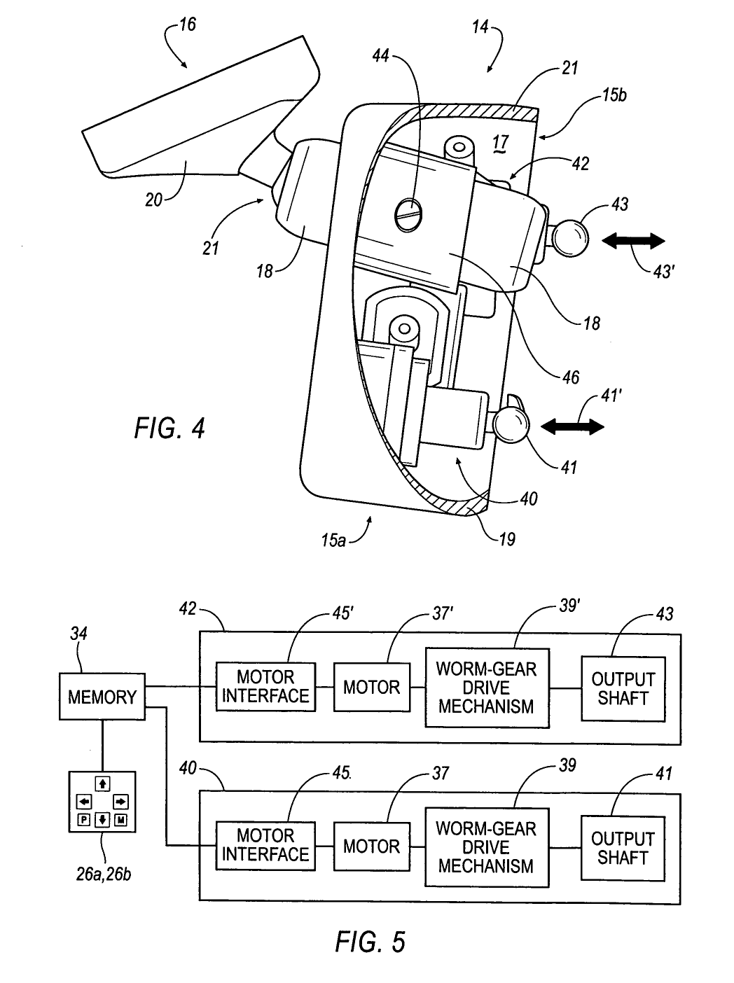

The first illustrated control pad, which is shown generally at 26a, may be located remote from the frame 24. The second illustrated control pad, which is shown generally at 26b, may be located proximate the frame 24. The location of the first control pad 26a may be, for example, proximate an armrest, A (FIG. 2), or the like. According to the illustrated embodiment, the armrest, A, may be, for example, a center-console armrest between two front seats, or, alternatively, a front or rear door armrest. Although first and second control pads 26a, 26b are shown in FIG. 1, it will be appreciated that the system 10 may include any number of control pads 26a, 26b positioned at any desirable location within the passenger compartment area. Even further, it will be appreciated that a control pad 26a, 26b may be located remote from, or, as a separate component of the vehicle such as, for example, a key fob, which is shown generally at K in FIG. 4.

Each control pad 26a, 26b is illustrated to include one or more operating devices, which may include, for example, directional switches, a joystick, track ball, touch panel, or the like, which are generally exemplified at 28. According to the illustrated embodiment, operating device are illustrated with up, down, left, and right arrow indicia or other indicators.

When one of the operating devices 28 is activated, the power-adjust mechanism 14 moves (e.g. rotates, pivots, or tilts) the mirror structure 12 along a vertical arc V about a first axis X and/or a horizontal arc H about a second axis Y. For example, pressing the up or down arrow operating devices 28 causes a vertical pitch adjustment of the mirror structure 12 along the vertical arc, V. Pressing the left or right arrow operating devices 28 causes a horizontal pitch adjustment of the mirror structure 12 along the horizontal arc, H.

The control pads 26a, 26b are also shown to include a program operating device 30, which, in the exemplary embodiment, is labeled with an indicia “P,” and a memory operating device 32, which is labeled with an indicia “M”. As similarly described above, the program and memory operating devices 30, 32 may include, but are not limited to a switch, touch panel, or the like. Hereinafter, each operating device 30, 32 is referred to as a program switch 30 and a memory switch 32, respectively. When the program switch 30 is depressed, the position of the mirror structure 12 is detected and stored in a memory location within memory 34. Each time that the memory switch 32 is activated, stored position data of the mirror structure 12 is recalled from a memory location within memory 34 and delivered to power-adjust mechanism structure 14 wherein the vertical pitch and/or horizontal pitch of the mirror structure 12 is adjusted to match the recalled position data.

The memory 34 can be configured to store multiple mirror position settings (i.e. each memory location within memory 34 may store a unique mirror position setting). Each time the memory switch 32 is activated, the next position setting stored in memory 34 is accessed and sent to power adjust mechanism structure 14. According to an embodiment, memory 34 may be configured as a ring-buffer memory structure to provide sequential access to the stored position settings such that each time memory switch 32 is activated, the next memory location containing valid mirror structure position data is accessed. If desired, the memory switch 32 may be linked to other memory presets associated with other devices in the vehicle including, but not limited to a positioning of a side-view mirror, M, power seats, S, radio presets for a radio, R, or the like. Accordingly, for example, when two principle drivers such as a husband and wife use the vehicle, the memory 34 may not only store settings for the mirror structure 12, but also, any desirable settings for the vehicular components, S, M, R, or the like. By linking two or more M, S or R presets to at least one memory switch 32, a driver can conveniently position two or more M, S, or R devices with a single activation of switch 32. In an alternative embodiment, multiple memory switches can also be used wherein each switch 32 is respectively associated with one device (e.g. M, S, and R).

The remote control pad 26a may include a wired or wireless communication channel 36 with the memory 34, and the memory 34 may include a wired or wireless communication channel 38 with the power-adjust mechanism structure 14. If the memory 34 is not included in the system 10, the wired or wireless communication channel 36 may be directly provided from the remote control pad 26a to the power-adjust mechanism structure 14. Because the control pad 26b is located proximate the mirror structure 12, the control pad 26b may include a wired communication channel (not shown) with the power-adjust mechanism structure 14; however, if desired, the control pad 26b may communicate with the power-adjust mechanism structure 14 over a wireless channel (not shown).

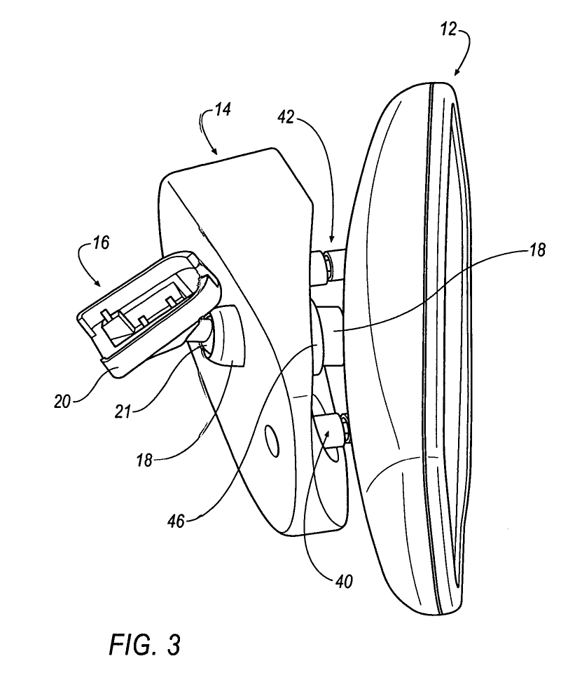

Referring to FIGS. 1, 3 and 4, an embodiment of a power-adjust mechanism structure 14 is shown to include a vertical pitch mechanism, which is shown generally at 40 proximate a bottom portion 15a of the power-adjust mechanism structure 14, and a horizontal pitch mechanism, which is shown generally at 42 proximate a side portion 15b of the power-adjust mechanism structure 14. As illustrated, a cylindrical sleeve body portion 46 of the power-adjust mechanism structure 14 is received around and attached to the attachment rod 18 by a set screw or the like, which is shown generally at 44 in FIG. 4. The horizontal pitch mechanism 42 and the vertical pitch mechanism 40 may be attached at any convenient location to power-adjust mechanism structure 14. Mechanism 40, 42 may be housed within an inner chamber 17 formed by side walls 19, 21 of power adjust mechanism structure 14.

Each vertical and horizontal pitch mechanism 40, 42 may include, for example, without limitation, a motor 37, 37′ coupled to a worm gear drive mechanism 39, 39′. In operation, motor interface portions 45, 45′ of mechanisms 40, 42 receive electrical signals from either the operating devices 28 of the control pads 26a, 26b, or, alternatively, saved position settings stored in memory 34 which are used, to activate motors 37, 37′. The motors 37, 37′ drive their respective worm gear drive mechanism 39, 39′ to effect movement of each motor's respectively associated pitch mechanism output shaft 41, 43. Motor interface 45, 45′ is shown as part of mechanism 40, 42 but one skilled in the art will readily recognize that it can be placed in any location within the vehicle.

Upon activation of the up/down or left/right operating devices 28 by an operator, or if the memory switch 32 is activated by the operator, the one or both motors 37, 37′ are energized, thereby causing one or both output shafts 41, 43 to move along a respectively associated path 41′, 43′. Movement 41′ by shaft 41 causes movement of mirror 22 along vertical path V, and movement 43′ by shaft 43 causes movement of mirror 22 along horizontal path H. The path traversed by movement 41′ and 43′ can be linear, arcuate or any other path sufficient for accomplishing movement of mirror 22 along horizontal arc H and vertical arc V. Although the mirror structure 12 and power-adjust mechanism structure 14 are shown as separate members, it will be appreciated that the mirror structure 12 and power-adjust mechanism structure 14 may be integrally manufactured as one unit, which may increase package density while reducing components and manufacturing cost.

System 10 overcomes deficiencies of conventional rear-view mirror systems by providing a motorized, power-adjust rear-view mirror. Even further, the memory 34 is capable of storing a plurality of rear-view mirror positions so that multiple vehicle operators can each store their preferred mirror settings which can for example, be activated or initiated by entry into a vehicle (such as, for example, pressing a switch on a key fob or entering a pad code).

Although the embodiments have been disclosed using switch activation initiated by the vehicle operator, it is contemplated that voice activation may also be used as a means of interface between the vehicle operator and the power-adjust rear view mirror system.

The present invention is shown and described herein with reference to the foregoing embodiments, which are merely illustrative of the best modes for carrying out the invention. It is to be understood by those skilled in the art that various alternatives to the embodiments disclosed herein may be employed in practicing the invention without departing from the spirit and scope of the invention as defined in the claims. The claims define the scope of the invention and all methods and apparatus disclosed herein fall within the scope of these claims and their equivalents. The description of the invention includes all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A power-adjust rear view mirror system, comprising:
a power-adjust mechanism structure coupled to a mirror structure, wherein the power-adjust mechanism structure and the mirror structure are located within a passenger compartment of a vehicle; and
one or more operating devices that, when activated, actuate the power-adjust mechanism structure to manipulate a position of the mirror structure relative to a vehicle operator.

2. The power-adjust rear view mirror system according to claim 1, wherein,
the power-adjust mechanism structure includes a sleeve portion received by and attached to an attachment feature, wherein said attachment feature is connected to a support structure, wherein the support structure is connected to one of an inboard surface of a front windshield or a headliner of the vehicle.

3. The power-adjust rear view mirror system according to claim 1, wherein the power-adjust mechanism structure includes a vertical pitch mechanism and a horizontal pitch mechanism.

4. The power-adjust rear view mirror system according to claim 3, wherein the vertical pitch mechanism and horizontal pitch mechanism each include a motor coupled to a drive mechanism, wherein each motor receives signals initiated from the one or more operating devices or a saved position signal setting stored in a memory.

5. The power-adjust rear view mirror system according to claim 1, wherein the one or more operating devices are mounted to a control pad located remotely from the mirror structure.

6. The power-adjust rear view mirror system according to claim 5, wherein the control pad is located proximate an arm rest in the passenger compartment.

7. The power-adjust rear view mirror system according to claim 1, wherein the one or more operating devices are mounted to two control pads.

8. The power-adjust rear view mirror system according to claim 1, wherein the mirror structure includes a mirror and a frame.

9. The power-adjust rear view mirror system according to claim 8, wherein the one or more operating devices are mounted to a control pad attached to the mirror structure.

10. The power-adjust rear view mirror system according to claim 9, wherein the control pad is connected to the frame.

11. The power-adjust rear view mirror system according to claim 1, wherein the one or more operating devices include respectively associated printed indicia, and wherein when one of said one or more operating devices is activated, the power-adjust mechanism structure manipulates the position of the mirror structure.

12. The power-adjust rear view mirror system according to claim 11, wherein said power-adjust mechanism structure manipulates a pitch of the mirror structure along a vertical arc, about a first axis X and along a horizontal arc about a second axis Y.

13. The power-adjust rear view mirror system according to claim 1, further including:
a memory that stores vertical and horizontal pitch position data associated with a position of the mirror structure.

14. The power-adjust rear view mirror system according to claim 13, wherein the one or more operating devices are mounted to a control pad, and wherein the one or more operating devices further include a program switch, that, when activated, causes data representative of a vertical pitch position and horizontal pitch position of the mirror structure to be stored in the memory.

15. The power-adjust rear view mirror system according to claim 14, wherein the control pad includes a memory switch, that, when activated, causes the mirror structure to be manipulated to a vertical pitch position and horizontal pitch position consistent with a previously stored vertical and horizontal pitch position of the mirror structure.

16. A power-adjust rear view mirror system, comprising:
power-adjusting means for adjusting a mirror located within a passenger compartment of a vehicle, and
operating means, interacting with the power-adjusting means, for manipulating a vertical pitch and a horizontal pitch position of the mirror relative to a vehicle operator.

17. The power-adjust rear view mirror system according to claim 16, wherein the operating means is mounted to a control pad located remote from the mirror.

18. The power-adjust rear view mirror system according to claim 16, wherein the mirror is accompanied with a frame.

19. The power-adjust rear view mirror system according to claim 16, further including:
storing means for storing position data associated with the vertical pitch position and the horizontal pitch position of the mirror.

20. The power adjust rear view mirror system according to claim 16, wherein said power adjust means further includes at least one pitch mechanism having a motor coupled between a drive mechanism and a motor interface.
